(19) United States
(12) Patent Application Publication
(10) Pub. No.: US 2012/0137532 A1
(43) Pub. Date: Jun. 7, 2012

(54) Template combination for use in clothing manufacture

(75) Inventor: Fang Chi Yeh, Taipei (TW)

(73) Assignee: Le Summit Industrial Co., Ltd.

(21) Appl. No.: 12/928,224

(22) Filed: Dec. 7, 2010

(51) Int. Cl. G01B 3/00; G01B 1/00

(52) U.S. Cl. 33/562

(57) ABSTRACT

A template device includes an outer template member having a chamber formed in an inner peripheral surface, an inner template member engaged onto the chamber of the outer template member, and one or more intermediate template members disposed between the outer and the inner template members, and the intermediate template member includes a space formed in an inner peripheral surface for receiving the inner template member, the inner template member includes a compartment formed in an inner peripheral surface for receiving a center template member, the template members each include one or more holes selected from a dotted hole, an oblong hole, or a pattern hole for drafting circles or patterns on a clothing material.

### BACKGROUND OF THE INVENTION

1. Field of the Invention

The present invention relates to a template assembly or combination, and more particularly to a template assembly or combination for use in garment or clothing manufacture and including an improved compact structure for facilitating the storing and transportation purposes and for weight reducing purposes.

2. Description of the Prior Art

Typical template for pattern drawing and measuring purposes comprise a circular plate including many holes formed therein, and including one or more graduations or indicia formed or provided therein for pattern drawing or drafting purposes.

For example, U.S. Pat. No. 3,795,053 to Burke, and U.S. Pat. No. 4,129,948 to Hatter et al. disclose two of the typical combination drafting instruments or circle drawing and measuring devices each comprising a template member including many holes and graduations or indicia formed or provided therein for drawing or drafting circles on clothing materials or paper members or the like.

However, a center pin is required to be provided or disposed or engaged onto the clothing materials or paper members or the like for circle or pattern drawing or drafting purposes, and it will be difficult to draw or draft circles on the clothing materials with such typical combination drafting instruments or circle drawing and measuring devices.

U.S. Pat. No. 4,565,006 to Vouyouka discloses another typical template for use in garment or clothing manufacture and including a flat plate like template member with a series of apertures having contours conforming in shape to a desired pattern for marking out a pattern for the manufacture of garments or clothing materials.

However, the template member may not be used to easily and quickly draw or draft circles on the clothing materials or paper members or the like.

U.S. Pat. No. 5,076,612 to Nirmel discloses a further typical system and method for accurately locating objects of assorted shapes and sizes on a substantially vertical supporting surface comprising a flat elongate and marked sheet for making or forming shape replicates with various objects.

However, the objects for marking purposes are separated pieces and may not be stacked or superposed with each other and may not be formed into a compact structure for storing and transportation purposes.

The present invention has arisen to mitigate and/or obviate the afore-described disadvantages of the conventional template assemblies or combinations.

### SUMMARY OF THE INVENTION

The primary objective of the present invention is to provide a template assembly or combination for use in garment or clothing manufacture and including an improved compact structure for facilitating the storing and transportation purposes and for weight reducing purposes.

In accordance with one aspect of the invention, there is provided a template assembly or combination comprising a first or outer template member including a chamber formed therein for forming an inner peripheral surface, and the first or outer template member including an outer peripheral surface formed therein, a second or inner template member engaged onto the chamber of the first template member and including an outer peripheral surface formed therein, and at least one third or intermediate template member engaged onto the chamber of the first template member and disposed between the first and the second template members, and including a space formed therein for forming an inner peripheral surface therein and for receiving the second template member, and including an outer peripheral surface formed therein.

The second template member includes a compartment formed therein for forming an inner peripheral surface therein. A center template member may further be provided and fitted and engaged in the compartment of the second template member.

The first template member includes at least one hole formed therein, and the hole of the first template member is selected from a dotted hole, an oblong hole, or a pattern hole for making or drawing or drafting or forming circles or patterns on a clothing material.

The second template member includes at least one hole formed therein, and the hole of the second template member is selected from a dotted hole, an oblong hole, or a pattern hole for making or drawing or drafting or forming circles or patterns on a clothing material.

The third template member includes at least one hole formed therein, and the hole of the third template member is selected from a dotted hole, an oblong hole, or a pattern hole for making or drawing or drafting or forming circles or patterns on a clothing material.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a template assembly or combination in accordance with the present invention;

FIG. 2 is a side plan schematic view of the template assembly or combination;

FIG. 3 is an exploded view of the template assembly or combination;

FIG. 4 is a partial perspective view illustrating the operation of the template assembly or combination; and

FIG. 5 is a partial perspective view similar to FIG. 4 illustrating the operation of the template assembly or combination.

### DETAILED DESCRIPTION OF THE PREFERRED EMBODIMENT

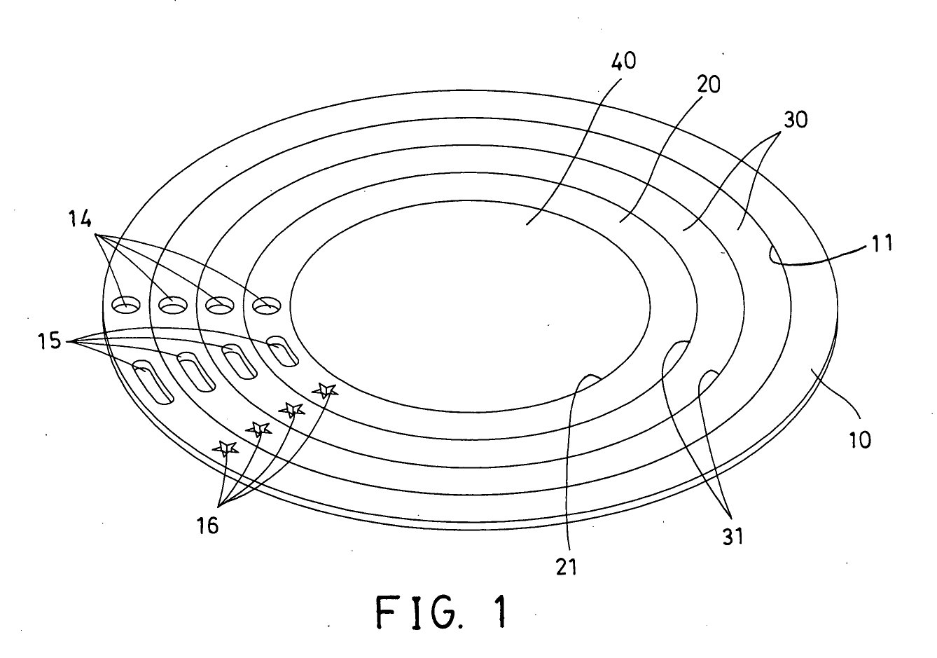

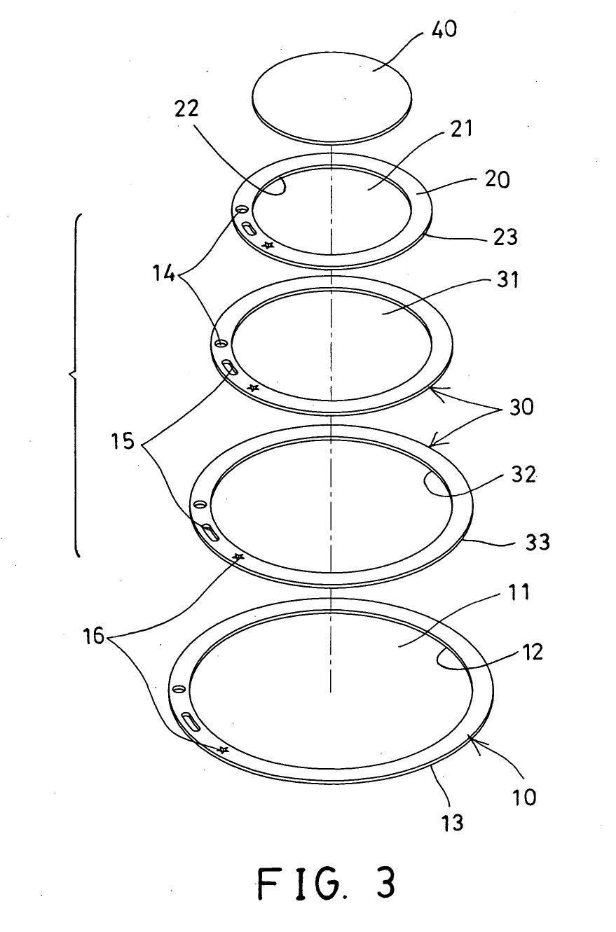

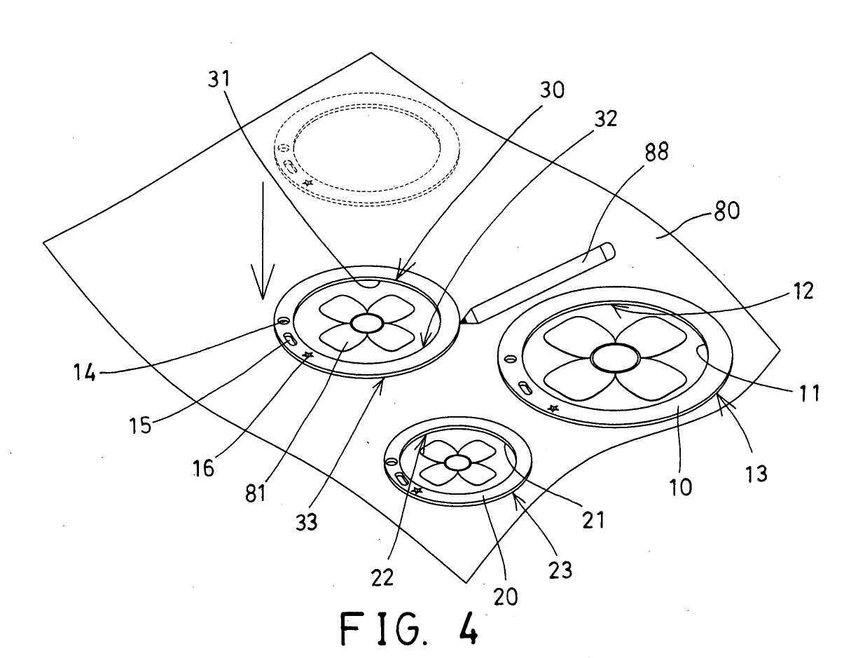

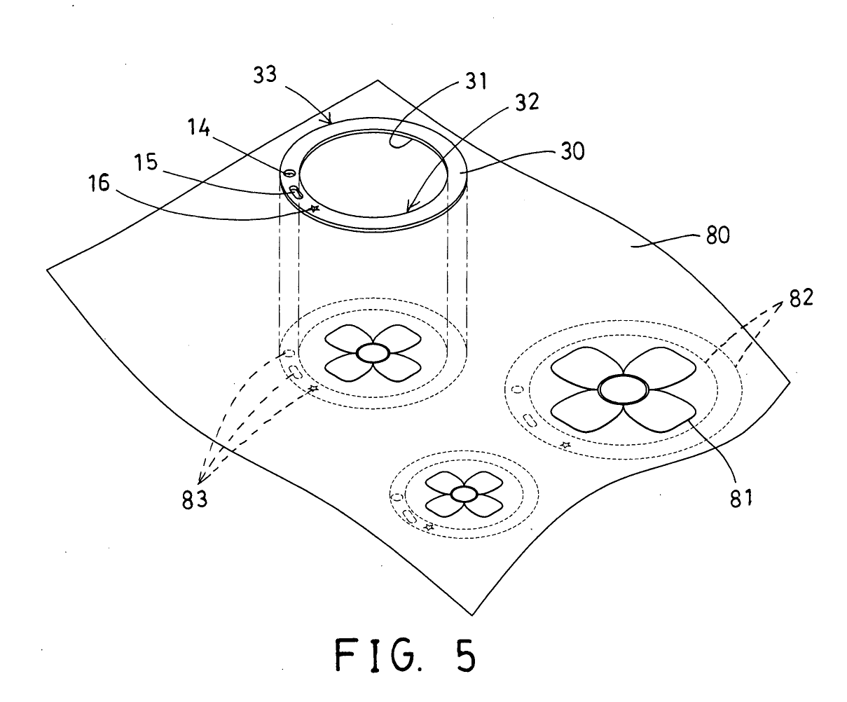

Referring to the drawings, and initially to FIGS. 1-3, a template assembly or combination in accordance with the present invention comprises a first or outer template member 10 including a bore or chamber 11 formed therein, such as formed in the center portion thereof for forming or defining an inner peripheral surface 12 therein, and including an outer peripheral surface 13 formed therein, and including one or more dotted holes 14 and/or one or more oblong holes 15 and/or one or more pattern holes 16 formed therein for making or drawing or drafting or forming circles 82 or patterns 83 on a clothing material 80 (FIGS. 4, 5), and/or around a pattern or mark 81 that is provided on the clothing material 80, and for stitching or embroidering purposes.

The template assembly or combination in accordance with the present invention further comprises a second or inner template member 20 disposed or engaged onto the chamber 11 of the first or outer template member 10 and including a bore or compartment 21 formed therein, such as formed in the center portion thereof for forming or defining an inner peripheral surface 22 therein, and including an outer peripheral surface 23 formed therein, and also including one or more dotted holes 14 and/or one or more oblong holes 15 and/or one or more pattern holes 16 formed therein for making or drawing or drafting or forming circles 82 or patterns 83 on a clothing material 80 (FIGS. 4, 5), and/or around a pattern or mark 81 that is provided on the clothing material 80, and for stitching or embroidering purposes.

The template assembly or combination in accordance with the present invention further comprises one or more (such as two) third or intermediate template members 30 engaged onto the chamber 11 of the first template member 10 and disposed or engaged between the first or outer template member 10 and the second or inner template member 20, and each including a bore or space 31 formed therein, such as formed in the center portion thereof for forming or defining an inner peripheral surface 32 therein and for receiving or engaging with the second or inner template member 20, and each including an outer peripheral surface 33 formed therein, and each also including one or more dotted holes 14 and/or one or more oblong holes 15 and/or one or more pattern holes 16 formed therein for making or drawing or drafting or forming circles 82 or patterns 83 on a clothing material 80 (FIGS. 4, 5), and/or around a pattern or mark 81 that is provided on the clothing material 80, and for stitching or embroidering purposes. A center template member 40 may further be provided and fitted or engaged in the compartment 21 of the second or inner template member 20.

As also shown in FIGS. 1-3, it is preferable that the third or intermediate template members 30 include an outer diameter equal to or slightly smaller than that of the inner diameter of the chamber 11 of the first or outer template member 10 for snuggly fitting or engaging in the chamber 11 of the first or outer template member 10 and for allowing the third or intermediate template members 30 and the first or outer template member 10 to be flush with each other, and similarly, the second or inner template member 20 includes an outer diameter equal to or slightly smaller than that of the inner diameter of the space 31 of the third or intermediate template members 30 for snuggly fitting or engaging in the space 31 of the third or intermediate template members 30 and for allowing the second or inner template member 20 to be flush with the third or intermediate template members 30 and the first or outer template member 10. The center template member 40 includes an outer diameter equal to or slightly smaller than that of the inner diameter of the compartment 21 of the second or inner template member 20 for snuggly fitting or engaging in the compartment 21 of the second or inner template member 20.

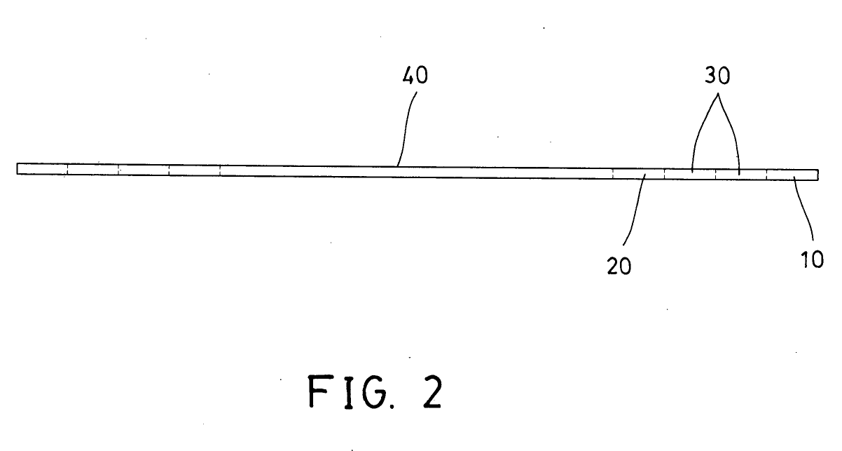

In operation, as shown in FIGS. 4 and 5, either of the template members 10, 20, 30, 40 may be disposed or engaged onto the paper members or clothing material 80, and may be used to draw or draft circles 82 or patterns 83 on the paper members or clothing materials 80 with, for example, a pen 88 (FIG. 4), and/or around a pattern or mark 81 that is provided on the paper members or clothing material 80, and the circles 82 or the patterns 83 may then be used to stitch or embroider threads or the like onto the paper members or clothing material 80. It is to be noted that, as shown in FIGS. 1 and 2, the template members 10, 20, 30, 40 are flush with each other or have the same thickness for allowing the template members 10, 20, 30, 40 of the template assembly or combination to be easily carried with the user. The template members 10, 20, 30, 40 may be made of plastic or rubber or soft or resilient materials and may be formed or shaped into various kinds of shapes, such as triangles, rectangles, squares, polygons, or the like.

Accordingly, the template assembly or combination in accordance with the present invention is provided for use in garment or clothing manufacture and includes an improved compact structure for facilitating the storing and transportation purposes and for weight reducing purposes.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A template assembly or combination comprising:
a first template member including a chamber formed therein for forming an inner peripheral surface, and said first template member including an outer peripheral surface formed therein,
a second template member engaged onto said chamber of said first template member and including an outer peripheral surface formed therein, and
at least one third template member engaged onto said chamber of said first template member and disposed between said first and said second template members, and including a space formed therein for forming an inner peripheral surface therein and for receiving said second template member, and including an outer peripheral surface formed therein.

2. The template assembly or combination as claimed in claim 1, wherein said second template member includes a compartment formed therein for forming an inner peripheral surface therein.

3. The template assembly or combination as claimed in claim 2 further comprising a center template member fitted and engaged in said compartment of said second template member.

4. The template assembly or combination as claimed in claim 1, wherein said first template member includes at least one hole formed therein.

5. The template assembly or combination as claimed in claim 4, wherein said at least one hole of said first template member is selected from a dotted hole, an oblong hole, or a pattern hole.

6. The template assembly or combination as claimed in claim 1, wherein said second template member includes at least one hole formed therein.

7. The template assembly or combination as claimed in claim 6, wherein said at least one hole of said second template member is selected from a dotted hole, an oblong hole, or a pattern hole.

8. The template assembly or combination as claimed in claim 1, wherein said third template member includes at least one hole formed therein.

9. The template assembly or combination as claimed in claim 8, wherein said at least one hole of said third template member is selected from a dotted hole, an oblong hole, or a pattern hole.
